(19) United States
(12) Patent Application Publication
(10) Pub. No.: US 2024/0020645 A1
(43) Pub. Date: Jan. 18, 2024

(54) METHODS AND APPARATUS FOR GENERATING BEHAVIORALLY ANCHORED RATING SCALES (BARS) FOR EVALUATING JOB INTERVIEW CANDIDATE

(71) Applicant: iCIMS, Inc., Holmdel, NJ (US)

(72) Inventors: Celine BARRIL, Paris (FR); Leo HEMAMOU, Antony (FR); Arthur GUILLON, Paris (FR)

(21) Appl. No.: 17/863,081

(22) Filed: Jul. 12, 2022

(51) Int. Cl. G06Q 10/10

(52) U.S. Cl. CPC G06Q 10/1053

(57) ABSTRACT

A computer-implemented method is described herein. The method can include receiving a transcript of a job interview of a candidate. The transcript can include at least one response to at least one behavioral question. The method can further include identifying a critical incident from the at least one response, classifying the critical incident into a first cluster of a plurality of clusters based in part on a measurement of similarity between the first cluster and the critical incident, and outputting an output score for the at least one response using the model. Each cluster of the plurality of clusters can represent an archetype behavior from a plurality of archetype behaviors that are associated with the at least one behavioral question. The output score can be based on a first score associated with the archetype behavior of the first cluster.

### TECHNICAL FIELD

The present disclosure relates to the field of data processing and artificial intelligence including, for example, methods and apparatus for automatically generating behaviorally anchored rating scales for evaluating job interviews.

### BACKGROUND

Candidates are typically assessed for a job position, promotion, special assignment, and/or the like based on interviews. A hiring manager and/or other individuals (e.g., recruiters, supervisors, boss, executives, etc.) interview various candidates to obtain information about the candidate's behavior, strengths, weakness, etc. The responses from these interviews are evaluated to determine the most suitable candidate for the position. Evaluating interview responses can, however, be time consuming. Furthermore, the time used to evaluate interview responses often increase with an increase in the number of candidates that are being considered. This can pose a major challenge for organizations since the time allocated by most organizations to fill a job position is often limited. Additionally, the challenge is exacerbated for large organizations that often have several positions to be filled simultaneously.

More recently, artificial intelligence tools and methods to evaluate interview responses have been developed. Known methods, however, are not structured to evaluate candidates based on specificities of the job positions. For instance, these known methods use shallow knowledge of positions and/or organizations to assess candidates. In particular, these methods do not incorporate knowledge from hiring managers when evaluating candidates. This can impact the accuracy of the evaluations. Additionally, these evaluations can be fuzzy since they are not specific to specific positions, thereby making the interpretability of the results from these existing methods often difficult.

Therefore, an unmet need exists for methods and apparatus that can automatically evaluate candidates for job positions accurately and reliably in a timely and efficient manner.

### SUMMARY

In some embodiments, a computer-implemented method is described herein. The method can include receiving a transcript of a job interview of a candidate. The transcript can include at least one response to at least one behavioral question. The method can also include identifying a critical incident from the at least one response using a model, and classifying the critical incident into a first cluster of a plurality of clusters based at least in part on a measurement of similarity between the first cluster and the critical incident using the model. Each cluster of the plurality of clusters can represent an archetype behavior from a plurality of archetype behaviors that are associated with the at least one behavioral question. The method can also include outputting an output score for the at least one response based on a first score associated with the archetype behavior of the first cluster using the model.

In some embodiments, a computer-implemented method can include receiving a training dataset that includes a plurality of responses to a behavioral question obtained from a plurality of candidates. Each response of the plurality of responses can be pre-annotated to represent antecedent-behavior-consequence schema of behavior. The method can also include extracting, from each response of the plurality of responses, a behavior from that response to generate a plurality of behaviors based at least in part on the pre-annotation for that response, clustering into a plurality of clusters the plurality of behaviors based on a semantic similarity of each behavior of the plurality of behaviors to each other behavior of the plurality of behaviors, and constructing a set of archetype behaviors for the behavioral question. Each archetype behavior of the set of archetype behaviors can be representative of a different cluster of the plurality of clusters. The method can also include generating behaviorally anchored rating scales (BARS) for the set of archetype behaviors, and training a model based on the plurality of clusters and the BARS.

### BRIEF DESCRIPTION OF THE DRAWINGS

FIG. 1 is a schematic description of a candidate evaluation device, according to an embodiment.

FIG. 2 is an example pre-annotated response in the training data, according to an embodiment.

FIG. 3 illustrate an example BARS for behaviors relating to customer service, according to an embodiment.

FIG. 4 is a flowchart depicting a method for training a model for evaluating candidates for a job position, according to an embodiment.

FIG. 5 is a flowchart depicting a method for automatically evaluating candidates for a job position, according to an embodiment.

### DETAILED DESCRIPTION

Non-limiting examples of various aspects and variations of the embodiments are described herein and illustrated in the accompanying drawings.

Embodiments described herein relate to apparatus and methods for evaluating candidates for job positions (e.g., job opening, promotion, special assignment, etc.) in a reliable, accurate, efficient, and automatic manner. The technology described herein automatically generates behaviorally anchored rating scales (BARS) for evaluating candidates for job positions.

As used herein, the terms “automatic,” and/or “automatically,” can refer to apparatus and methods (e.g., apparatus and methods for evaluating candidates for job positions as described herein) that perform one or more tasks (e.g., evaluating candidates, generating BARS, etc.) with minimal or no human interaction and/or input from humans.

Generally, to fill a job position organizations interview various candidates. One or more hiring managers (e.g., recruiters, supervisors, boss, executives, a combination thereof, and/or the like) often design a series of interview questions to evaluate these various candidates. These interview questions often include past behavioral or situational questions that may be specific to the job position. For example, if the job position requires that the candidates be facing customers, then interview questions specific to this job position may include questions related to past situations where the candidates had to deal with customers. Similarly, if the job position is a managerial position, the interview questions specific to this job may include questions related to past situations where the candidates had to manage a team.

The hiring managers typically evaluate various candidates depending on their responses to the series of interview questions. Often, the hiring managers incorporate their knowledge of the specific positions while evaluating candidates. For example, for the customer facing job position, the hiring managers may give more weight to the responses to the interview questions related to dealing with customers. In a similar manner, for the managerial position, the hiring managers may give more weight to the responses to the interview questions related to managing a team. In this manner, using the knowledge of specific job positions, hiring managers can evaluate the candidates in a fairly accurate manner.

Although evaluation of the candidates by hiring managers can be fairly accurate, in some situations, these evaluations can be biased. For example, it may be possible that hiring managers may favor some candidates over the others based on factors such as gender, race, age, etc. Accordingly, evaluation of candidates by hiring managers may not always be reliable. Behaviorally anchored rating scales (BARS) were developed to eliminate bias from such interview evaluations.

BARS are scales that can be used to rate interview responses. Organizations, for example, can assemble a team of experts, such as for example, hiring managers to develop BARS. Hiring managers can identify behavioral and/or situational questions that include questions related to the specific job position. Based on their experience, hiring managers can identify a set of archetype behaviors as a response to a behavioral and/or situational question. For instance, hiring managers can identify archetypal effective behaviors for the question that would increase the probability of a candidate succeeding in the job position. Similarly, hiring managers can identify archetypal ineffective behaviors for the question that would reduce the chances of a candidate succeeding in the job position. Once the set of archetype behaviors are identified, the hiring managers rate these archetype behaviors based on a scale. For instance, on a scale of 1 to 10, the most effective archetype behavior may be given a rating of 10 and the least effective archetype behavior may be given a rating of 1. After the scale has been set, the candidates are interviewed. The responses from the candidates can then be compared to the set of archetype behaviors. Based on these comparisons, hiring managers rate the responses of the candidates. The candidates are then evaluated based on their response ratings on the BARS scale. In this manner, by providing a reliable scale to evaluate candidates, BARS can eliminate (or at least reduce) bias from interview evaluations.

Although BARS eliminates (or at least reduces) bias, there are challenges associated with using existing methodologies to generate BARS and evaluate candidates. First, developing BARS can be time consuming. Often, organizations spend an enormous amount of time and resources into developing BARS. Second, the hiring managers typically need to be experienced to develop BARS. Additionally, hiring managers typically need to be heavily involved to develop BARS, thereby making them less productive in their day-to-day job.

In the recent times, some known technology uses artificial intelligence tools (e.g., machine learning techniques, etc.) to evaluate candidates automatically. These tools, however, do not incorporate knowledge and experience of the hiring managers during evaluations. Additionally, these tools are not based on reliable scales such as BARS. Accordingly, interpreting the results from such tools can be inexact.

One or more embodiments described herein overcome the challenges associated with existing methodologies for evaluating candidates. One or more embodiments described herein describe systems and methods for automatically generating BARS to reliably and accurately automate the process of evaluating candidates for a job position in an efficient manner. The technology described herein provides more accurate results and take less time and resources compared to known technologies/methodologies. Additionally, the technology described herein can incorporate knowledge, experience, and expertise of hiring managers to generate reliable results.

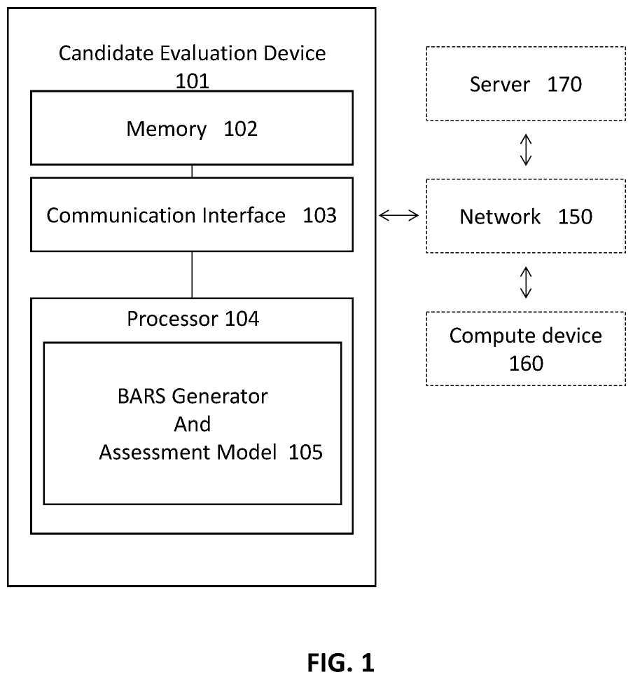

In some embodiments, a candidate evaluation device (e.g., candidate evaluation device 101 described herein in relation with FIG. 1) can be used to develop BARS and evaluate candidates in an automatic manner. For example, the candidate evaluation device can be used to automatically construct a set of archetype behaviors for a behavioral and/or situational question based on training data. The candidate evaluation device can automatically generate BARS for the set of archetype behaviors. The candidate evaluation device can train an assessment model based on the generated BARS and training data. The trained assessment model can be used to automatically evaluate candidates for a job position.

FIG. 1 is a schematic description of a candidate evaluation device 101, according to some embodiments. The candidate evaluation device 101 can be optionally coupled to a compute device 160 and/or a server 170. The server 170 and/or the compute device 160 can transmit and/or receive training data, evaluation output, artificial intelligence models (e.g., neural network models, machine learning models, etc.) and/or the like to and/or from the candidate evaluation device 101 via a network 150. The candidate evaluation device 101 can include a memory 102, a communication interface 103, and a processor 104. The candidate evaluation device 101 can operate a BARS generator and assessment model 105, which can evaluate candidates for a job position.

In some implementations, the candidate evaluation device 101 can be a compute device such as for example, computers (e.g., desktops, personal computers, laptops etc.), tablets and e-readers (e.g., Apple iPad®, Samsung Galaxy® Tab, Microsoft Surface®, Amazon Kindle®, etc.), mobile devices and smart phones (e.g., Apple iPhone®, Samsung Galaxy®, Google Pixel®, etc.), etc. In some implementations, the candidate evaluation device 101 can be a server that includes a compute device medium. The candidate evaluation device 101 can include a memory, a communication interface and/or a processor. In some embodiments, the candidate evaluation device 101 can include one or more processors running on a cloud platform (e.g., Microsoft Azure®, Amazon® web services, IBM® cloud computing, etc.).

To operate the BARS generator and assessment model 105, the candidate evaluation device 101 first receives training data via the communications interface 103. The training data can include behavioral and/or situational questions for a job position. The training data also includes responses to these behavioral and/or situational questions from candidates who have previously been interviewed for the same and/or similar job position (e.g., same and/or similar job positions in the same organization, and/or same and/or similar job positions in other organizations). These responses can be pre-annotated (e.g., by one or more hiring managers of an organization). In some embodiments, pre-annotated responses from candidates who have previously interviewed for the job position may be associated with the behavioral and/or situational questions in the training data. For example, hiring managers can pre-annotate the responses from previous candidates based on an antecedent-behavior-consequence schema. More specifically, the responses can be pre-annotated by hiring managers to underscore antecedent (e.g., events, actions, or circumstances that occur before a behavior), behavior (also referred to as “critical incident”), and consequences (e.g., action or response that follows a behavior) in the responses from candidates who have been previously interviewed. These pre-annotated responses can be associated with the question, and can together form the training data.

In some embodiments, the training data can include questions and respective pre-annotated responses for a single job position. In some embodiments, the training data can include questions and respective pre-annotated responses for multiple job positions. If different jobs involve overlapping skills, then a same question and its respective pre-annotated responses can be associated with each of these different job positions in the training data. If different jobs involve completely different skills, then different questions and their respective pre-annotated responses can be associated with each of the respective different job positions in the training data. The training data can be, for example, in the form of audio data, text data, video data, a combination thereof, and/or the like.

In some embodiments, the memory 102 can store the training data. The memory 102 can be, for example, a memory buffer, a random-access memory (RAM), a read-only memory (ROM), a hard drive, a flash drive, and/or the like. In some embodiments, the memory 102 can store instructions to operate the BARS generator and assessment model 105. For example, the memory 102 can store software code including modules, functions, variables, etc. to operate the BARS generator and assessment model 105. In some embodiments, the results from the BARS generator and assessment model 105 (e.g., BARS scales for questions, candidate ratings, etc.) can be stored in the memory 102.

The memory 102 can be operatively coupled to the communications interface 103. Additionally or alternatively, the communications interface 103 can be operatively coupled to the processor 104. The communications interface 103 can facilitate data communication between the candidate evaluation device 101 and external devices (e.g., the network 150, the compute device 160, the server 170, etc.). The communications interface 103 can be, for example, a network interface card (NIC), a Wi-Fi® transceiver, a Bluetooth® transceiver, an optical communication module, and/or any other suitable wired and/or wireless communication interface. In some embodiments, the communications interface 103 can facilitate transfer of and/or receiving of training data, data associated with the BARS generator and assessment model 105, output of the BARS generator and assessment model 105 to and/or from the external devices via the network 150.

The network 150 can be, for example, a digital telecommunication network of servers and/or compute devices. The servers and/or compute devices on the network can be connected via one or more wired or wireless communication networks (not shown) to share resources such as, for example, data storage and/or computing power. The wired or wireless communication networks between servers and/or compute devices of the network 150 can include one or more communication channels, for example, a radio frequency (RF) communication channel(s), a fiber optic commination channel(s), an electronic communication channel(s), and/or the like. The network 150 can be and/or include, for example, the Internet, an intranet, a local area network (LAN), and/or the like.

The processor 104 can be any suitable processing device configured to run and/or execute a set of instructions or code, and may include one or more data processors, image processors, graphics processing units, digital signal processors, and/or central processing units. The processor 104 may be, for example, a general purpose processor, a Field Programmable Gate Array (FPGA), an Application Specific Integrated Circuit (ASIC), and/or the like. The processor 104 can include the BARS generator and assessment model 105. In some embodiments, the processor 104 can be configured to execute and/or implement the BARS generator and assessment model 105. The BARS generator and assessment model 105, when executed by the processor 104, can be configured to evaluate candidate interviews.

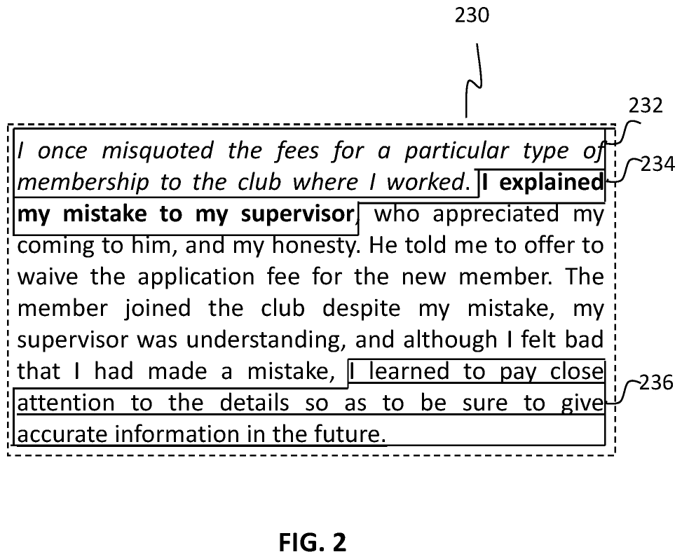

The BARS generator and assessment model 105 can receive training data via the communication interface 103. For example, the training data can be received from the compute device 160 and/or the server 170 via the communication interface 103. As discussed above, the responses in the training data can be pre-annotated and/or pre-labeled to represent antecedent-behavior-consequence schema of behavior. For example, FIG. 2 depicts a pre-annotated and/or pre-labeled example response 230 to the question—“Have you ever made a mistake while working at your previous job?” One or more hiring managers may pre-annotate/pre-label the responses to indicate antecedent-behavior-consequence schema of behavior. FIG. 2 depicts a pre-annotated/pre-labeled response 230 with annotation 232 representing antecedent, annotation 234 representing behavior, and annotation 236 representing consequence. The annotations can be any suitable type of annotations such as for example, different tags representing each of antecedent, behavior, and consequence, or different colors representing each of antecedent, behavior, and consequence, etc. In some embodiments, the “behavior” in antecedent-behavior-consequence schema is also referred to herein as “critical incident.”

In some embodiments, the BARS generator and assessment model 105 can be configured to identify a structure of each of the responses in the training data based on their annotations. For example, the BARS generator and assessment model 105 can be configured to identify antecedent, behavior, and/or consequence in each response based on the annotations. The BARS generator and assessment model 105 can automatically extract behavior from the pre-annotated/pre-labeled responses. For example, consider the example in FIG. 2. Since the response 230 is annotated with annotation 232 representing antecedent, annotation 234 representing behavior, and annotation 236 representing consequence, the BARS generator and assessment model 105 can identify the structure of the response 230. For instance, the BARS generator and assessment model 105 can automatically identify that the response 230 has antecedent-behavior-consequence schema and can extract the text associated with annotation 234 representing behavior from the pre-annotated response. Therefore, for the example in FIG. 2, the BARS generator and assessment model 105 can extract “I explained my mistake to my supervisor,” as behavior from the example response 230. The BARS generator and assessment model 105 can automatically extract the behavior from all the pre-annotated responses in the training data. In some embodiments, the BARS generator and assessment model 105 can associate the extracted behavior with the behavioral and/or situational question.

After extracting behavior from pre-annotated responses, behaviors associated with a same and/or similar question can be clustered based on their semantic similarity to each other. For instance, the BARS generator and assessment model 105 can include one or more natural language processing models configured to cluster and/or classify sentences and/or phrases based on their similarity to each other. Additionally or alternatively, the BARS generator and assessment model 105 can include a machine learning model and/or a neural network model (e.g., deep neural network, convoluted neural network, etc.) that can be trained to cluster and/or classify sentences and/or phrases based on their semantic similarity to each other.

Each cluster can include extracted behaviors that are semantically similar to each other. For instance, consider the behavior extracted from the response 230 in FIG. 2. The BARS generator and assessment model 105 can cluster the behavior “I explained my mistake to my supervisor” into a same cluster as a behavior “I narrated my mistake to my supervisor.” Behavior such as “I blamed my colleague for the mistake” may be clustered into a different cluster by the BARS generator and assessment model 105. In some embodiments, the BARS generator and assessment model 105 can be configured to filter out the outlier behaviors that cannot be classified into any cluster. For example, if an extracted behavior is not similar to a predetermined number of extracted behaviors in the training data, then the BARS generator and assessment model 105 can be configured to filter out such an extracted behavior. The predetermined number of extracted behaviors can be any suitable number such that less than a majority, less than half, less than one-fourth, etc. of the total number of extracted behaviors in the training data.

After clustering the extracted behaviors into different clusters, the BARS generator and assessment model 105 can construct an archetype behavior for each cluster. For instance, the BARS generator and assessment model 105 can associate an archetype behavior with each cluster. In some embodiments, the archetype behaviors can be predetermined by hiring managers. For instance, the hiring managers can initially identify a set of archetype behaviors to a question. A representation of this predetermined set of archetype behaviors can be received by the BARS generator and assessment model 105 via the communication interface 103 (e.g., as a part of the training data or separate from the training data). After clustering the behaviors in the training data, the BARS generator and assessment model 105 can associate an archetype behavior from the predetermined set of archetype behaviors to each cluster. In some embodiments, the BARS generator and assessment model 105 can automatically determine archetype behaviors based on the number of extracted behaviors associated with each question. As a solely illustrative example, if the number of extracted behaviors is 700 the BARS generator and assessment model 105 may determine a set of 7 archetype behaviors for the question. If however, the number of extracted behaviors is 900 the BARS generator may determine a set of 9 archetype behaviors for the question. After determining the set of archetype behaviors, the BARS generator and assessment model 105 can then associate each cluster with a dynamically determined archetype behavior.

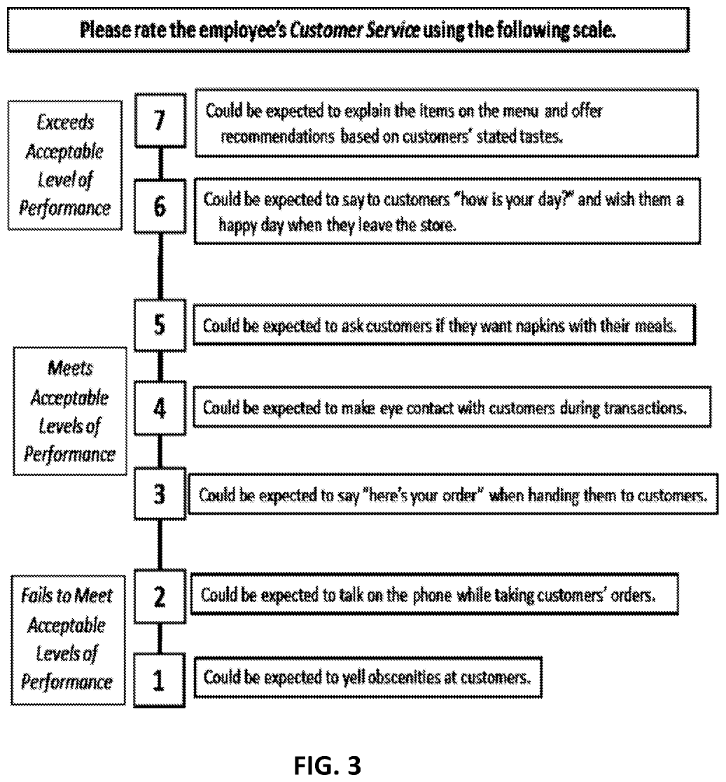

The BARS generator and assessment model 105 can generate BARS for the constructed set of archetype behaviors. As discussed above, BARS includes scores and/or weights assigned to each archetype behavior on a scale. FIG. 3 illustrates an example BARS for a set of archetype behaviors. In FIG. 3, the set of archetype behaviors are for questions relating to assessing a candidate's customer service skill. As discussed above, these set of archetype behaviors can be predetermined (e.g., by one or more hiring managers). Additionally or alternatively, these set of archetype behaviors can be constructed by the BARS generator and assessment model 105. As seen in FIG. 3, the set of archetype behaviors for customer service related questions can include yelling obscenities at customers, talking on the phone while taking customers' orders, asking customers if they want napkins with their meals, explaining items on the menu and offering recommendations, etc. These archetype behaviors can then be scored and/or weighted on a scale. In embodiments in which the archetype behaviors are predetermined, the scores and/or weights for the archetype behaviors can be received from one or more hiring managers via the communication interface 103 (e.g., with the training data or separate from the training data). In the embodiments in which archetype behaviors are determined dynamically, the BARS generator and assessment model 105 can automatically score and/or weight each archetype behavior in the set of archetype behaviors. In the example in FIG. 3, the archetype behaviors are scored on a scale of 1 to 7. The archetype behavior yelling obscenities at customer is given a score and/or weight of 1 (e.g., least score and/or poor behavior) and the archetype behavior explaining items on the menu and offering recommendations is given a score and/or weight of 7 (e.g., highest score and/or best behavior).

To evaluate the candidates, the BARS generator and assessment model 105 can receive a transcript of a job interview of a candidate via the communications interface 103. The transcript can be in any suitable form such as for example, a video, an audio, text, etc. The transcript can include the candidate's response to a behavioral and/or situational question. The BARS generator and assessment model 105 can be configured to determine a structure representing the antecedent-behavior-consequence schema of behavior in the response. For example, the BARS generator and assessment model 105 can be configured to parse the transcript and annotate and/or label the response. As discussed above, the BARS generator and assessment model 105 can include a neural network model (e.g., deep neural network, convolutional neural network, etc.). The neural network can be trained using the training data to annotate/label responses. For instance, as discussed above, the training data can include pre-annotated/pre-labeled responses with the antecedent-behavior-consequence schema. The neural network can be trained using these pre-annotated/pre-labeled responses to identify antecedent, behavior, and/or consequence in the candidate's response. The BARS generator and assessment model 105 can be configured to annotate/label the response to represent the antecedent-behavior-consequence schema. For example, the BARS generator and assessment model 105 can be configured to identify antecedent in the response and annotate it as antecedent (e.g., critical incident). Similarly, the BARS generator and assessment model 105 can be configured to identify behavior in the response and annotate it as behavior. In a similar manner, the BARS generator and assessment model 105 can be configured to identify consequence in the response and annotate it as consequence.

The BARS generator and assessment model 105 can be configured to identify behavior or critical incident in the response based on the annotation. After identifying and extracting the behavior, the BARS generator and assessment model 105 can be configured to classify the behavior into a cluster based on a semantic similarity between the behavior and each of the clusters that were generated using the training data. For example, the BARS generator and assessment model 105 can include a natural language processing model to determine semantic similarity between the behavior and each of the clusters. Additionally or alternatively, the neural network of the BARS generator and assessment model 105 can be trained to determine semantic similarity between the behavior and each of the clusters. The extracted behavior can be classified into a cluster that the behavior is most semantically similar too. For example, the natural language processing model and/or the neural network can be configured to calculate a similarity score between the extracted behavior and each of the clusters. Each cluster can be associated with its respective similarity score. The highest similarity score may represent the most similar cluster and the lowest similarity score may represent the least similar cluster. The extracted behavior can be classified into the cluster with the highest similarity score.

As discussed above, each cluster is associated with an archetype behavior and the archetype behavior is provided with a BARS score and/or weight based on the BARS that was generated using the training data. The BARS generator and assessment model 105 can be configured to identify the archetype behavior for the cluster that the extracted behavior is clustered/classified into. Additionally, the BARS generator and assessment model 105 can be configured to identify the BARS score and/or weight provided for the archetype behavior. The BARS generator and assessment model 105 can then assign the same BARS score and/or weight to the extracted behavior. In some embodiments, the response from which the behavior is extracted is also assigned the same score and/or weight.

The score and/or weight of the response can then be used to evaluate the candidate. For example, the BARS generator and assessment model 105 can be configured to combine the score of responses to each question the candidate was asked during the interview to determine a final score for the candidate. For instance, the BARS generator and assessment model 105 can determine the final score by adding the score given to each response the candidate gave during the interview. Additionally or alternatively, the BARS generator and assessment model 105 can be configured to weigh the scores given to each response based on the skill set for the job position. For instance, for a customer-facing position, the scores given to responses about customer service can be given a higher weight in comparison to scores given to responses about managing a team. The BARS generator and assessment model 105 can add the weight scores to determine the final score for the candidate.

The score of the response and/or the final score of the candidate can be transmitted to the compute device 160 and/or the server 170 via the network 150. The hiring managers can review the scores on the compute device 160 and/or the server 170 and then make a hiring decision based on the scores. In some implementations, the hiring managers can review the scores generated for a response and provide feedback to the candidate evaluation device 101 via the network 150. For example, if the hiring managers believe that a specific response deserves a score different from that generated by the candidate evaluation device 101, then the hiring managers can transmit these different scores to the candidate evaluation device 101. The BARS generator and assessment model 105 can verify the score of the response and/or the final score of the candidates based on the feedback from the hiring managers. In some implementations, the BARS generator and assessment model 105 can be updated based on the feedback from the hiring managers to improve accuracy during subsequent evaluations. In this manner, the candidate evaluation device 101 can evaluate candidates for a job position.

Some non-limiting examples of the compute device 160 include computers (e.g., desktops, personal computers, laptops etc.), tablets and e-readers (e.g., Apple iPad®, Samsung Galaxy® Tab, Microsoft Surface®, Amazon Kindle®, etc.), mobile devices and smart phones (e.g., Apple iPhone®, Samsung Galaxy®, Google Pixel®, etc.), etc. In some implementations, the server 170 can be/include a compute device medium particularly suitable for data storage purpose and/or data processing purpose. The server 170 can include a memory, a communication interface and/or a processor. In some embodiments, the server 170 can include one or more processors running on a cloud platform (e.g., Microsoft Azure®, Amazon® web services, IBM® cloud computing, etc.). The server 170 may be any suitable processing device configured to run and/or execute a set of instructions or code, and may include one or more data processors, image processors, graphics processing units, digital signal processors, and/or central processing units. The server 170 may be, for example, a general purpose processor, a Field Programmable Gate Array (FPGA), an Application Specific Integrated Circuit (ASIC), and/or the like.

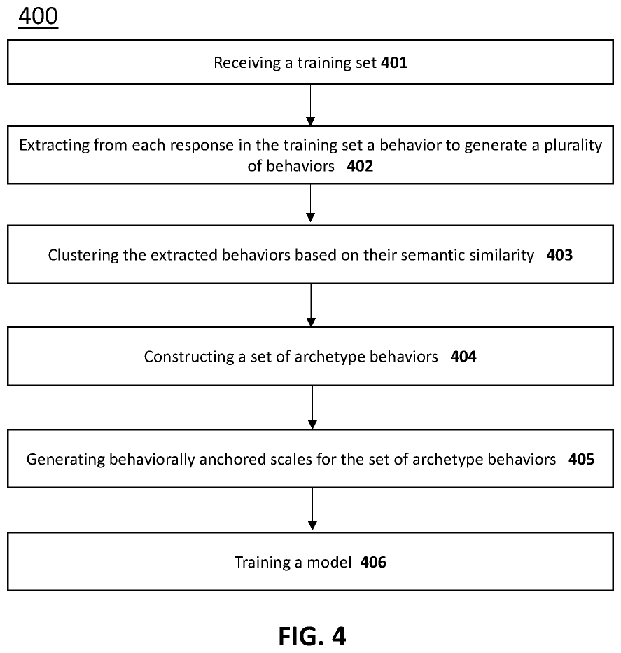

FIG. 4 is a flowchart depicting a method 400 for training a model for evaluating candidates for a job position, according to an embodiment. The method includes at 401, receiving a training dataset. The training dataset can include responses to questions from candidates that have been previously interviewed. The training dataset can include multiple questions, and responses to each of the multiple questions, from various candidates that were previously interviewed. In some embodiments, the responses can be associated with the questions in the training dataset. The training dataset can be pre-annotated (e.g., by one or more hiring managers). For example, the training dataset can be pre-annotated to represent antecedent-behavior-consequence schema of behavior.

At 402, the method 400 can include extracting from each response in the training dataset, a respective behavior to generate a plurality of behaviors. Extracting the behavior can be based on the pre-annotation/pre-labels. For example, method 400 can include identifying a structure for the response based on the pre-annotation/pre-labels. For instance, the portion of the response annotated/labeled as antecedent, the portion of the response annotated/labeled as behavior, and the portion of the response annotated/labeled as consequence can be identified. Once the structure for the response has been identified, the portion of the response annotated/labeled as behavior can be extracted from the response.

At 403, the method 400 can include clustering the extracted behaviors into a plurality of clusters based on their semantic similarity to each other. In some embodiments, the behavior extracted from responses to a single question can be clustered into a plurality of clusters. For example, if the training dataset includes 3 questions (e.g., a first question, a second question, and a third question) and responses from various candidates to the 3 questions, then the behaviors extracted from responses to the first question can be clustered into a first plurality of clusters, the behaviors extracted from responses to the second question can be clustered into a second plurality of clusters, and the behaviors extracted from responses to the third question can be clustered into a third plurality of clusters. Put differently, in some implementations, different clusters may be generated for behaviors associated with different questions. In some implementations, some questions can be similar to other questions in the training dataset. In such scenarios, the responses from the similar questions can be clustered together into the plurality of clusters.

At 404, the method can include constructing a set of archetype behaviors for the questions in the training dataset. For instance, each cluster in the plurality of clusters can be associated with an archetype behavior from the set of archetype behaviors. These archetype behaviors can be representative of the cluster that the archetype behavior is associated with. In some embodiments, the set of archetype behaviors for a question can be predetermined (e.g., by one or more hiring managers). The set of archetype questions can be included in the training dataset. In some implementations, the set of archetype behaviors can be automatically determined based on the number of responses to the question in the training dataset.

At 405, the method can include generating behaviorally anchored rating scales (BARS) for the set of archetype behaviors. For instance, one or more hiring managers can develop scores and/or weights for each archetype behavior in the set of archetype behaviors. The scores can be, for example, on a scale. The lowest score on the scale can represent the worst archetype behavior and the highest score on the scale can represent the best archetype behavior. In some implementations, the scores and/or weights can be assigned to each archetype behavior by the hiring managers. In some implementations, the score and/or the weights for the archetype behaviors can be automatically determined. For example, based on semantic analysis of the archetype behaviors, the method 400 can include automatically assigning scores and/or weights for the archetype behaviors in the set of archetype behaviors.

At 406, the method includes training a model based on the generated BARS and the clusters. The model can be any suitable artificial intelligence model such as a machine learning model, a neural network model (e.g., deep neural network), a natural language processing model, a combination thereof, and/or the like. The trained model can evaluate candidates for job positions using the BARS and the clusters.

It should be readily understood that one or more steps of method 400 can be performed automatically (e.g., with minimal and/or no human interaction and/or input from humans).

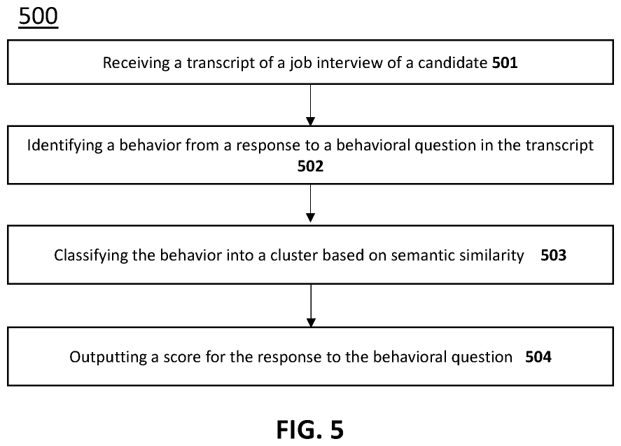

FIG. 5 is a flowchart depicting a method 500 for automatically evaluating candidates for a job position, according to an embodiment. At 501, the method includes receiving a transcript of a job interview from a candidate. The transcript can be in any suitable form such as for example, a video, an audio, text, etc. The transcript can include responses from the candidate to one or more behavioral and/or situational questions.

At 502, the method can include identifying a behavior from a response to the behavioral question in the transcript. In some implementations, the behavior can be identified using a model (e.g., model trained using method 400 in FIG. 4). The model can be any suitable artificial intelligence model such as a machine learning model, a neural network model (e.g., deep neural network), a natural language processing model, a combination thereof, and/or the like. In some implementations, the method can include identifying a structure of the response to the behavioral question. The structure can represent, for example, antecedent-behavior-consequence schema. The trained model can identify, for example, portions in the response that represent antecedent, portions in the response that represent behavior, and portions in the response that represent schema. In some implementations, the trained model can tag, label, and/or annotate these portions based on the identification. The portion annotated, labeled, and/or tagged as behavior can be identified as behavior. The method 400 can also include extracting the portion of the response identified as behavior.

After identification and/or extraction of behavior, at 503, the behavior can be classified into a cluster based on the semantic similarity between the behavior and the cluster. As discussed in FIG. 4, during training, a plurality of clusters can be generated based on the semantic similarity of the behaviors in the training data. The behaviors in each cluster can be semantically similar to each other behaviors within the cluster. Each cluster can be associated with an archetype behavior from a set of archetype behaviors. The archetype behavior can be representative of the behaviors within the cluster. The behavior extracted from the candidate's transcript can be compared to each of the plurality of clusters. For instance, the extracted behavior can be semantically compared to the archetype behavior associated with a cluster. Additionally or alternatively, the extracted behavior can be compared to all of the behaviors within the cluster. In yet other alternative implementations, the extracted behavior can be compared to a subset of behaviors within the cluster. Based on this comparison, the extracted behavior can be classified into a cluster that it is most semantically similar to.

As discussed herein, each archetype behavior can be assigned a score and/or a weight based on behaviorally anchored rating scales (e.g., BARS generated in FIG. 4). Once the extracted behavior has been classified into a cluster, the score and/or weight assigned to the archetype behavior associated with the cluster can be identified. At 504, the method can include outputting a score for the candidate's response to the behavioral question based on the identified score and/or weight assigned to the archetype behavior. In some embodiments, the method 500 can further include transmitting the score and/or weight assigned to the candidate's response to one or more hiring managers (e.g., via compute devices and/or servers). The method can further include updating the model based on feedback from the hiring managers.

It should be readily understood that one or more steps of method 500 can be performed automatically (e.g., with minimal and/or no human interaction and/or input from humans).

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages, packages, and software development tools.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A computer-implemented method, comprising:
receiving a transcript of a job interview of a candidate, the transcript including at least one response to at least one behavioral question;
identifying, using a model, a critical incident based on a pre-annotation of a behavior and consequence from the at least one response;
classifying, using the model trained using training data, the critical incident into a first cluster of a plurality of clusters based at least in part on a measurement of similarity between the first cluster and the critical incident, each cluster of the plurality of clusters representing an archetype behavior from a plurality of archetype behaviors that is associated with the at least one behavioral question and associated with a similarity score calculated based on that cluster and the critical incident, the training data including a behavioral question and an associated plurality of pre-annotated responses that are associated with each job from a plurality of different jobs, each job from the plurality of different jobs having an overlapping skill with at least one remaining job from the plurality of different jobs; and
outputting, using the model, an output score for the at least one response based on a first score associated with an archetype behavior of the first cluster, the first score associated with the archetype behavior of the first cluster is based on behaviorally anchored rating scales (BARS).

2. The computer-implemented method of claim 1, wherein the measurement of similarity between the first cluster and the critical incident indicates that the critical incident is most similar to the first cluster of the plurality of clusters in comparison to each other cluster of the plurality of clusters.

3. The computer-implemented method of claim 1, wherein the measurement of similarity represents semantic similarity between the first cluster and the critical incident.

4. The computer-implemented method of claim 1, wherein the model includes a deep neural network.

5. The computer-implemented method of claim 1, further comprising:
evaluating the candidate for a job related to the job interview based at least in part on the output score.

6. The computer-implemented method of claim 1, further comprising:
detecting, using the model and in the at least one response, a structure representing antecedent-behavior-consequence schema of behavior,
the identifying the critical incident including identifying the critical incident based on the structure.

7. The computer-implemented method of claim 1, further comprising:
annotating, using the model and based on a structure of the at least one response, a first portion of the at least one response as antecedent, a second portion of the at least one response as behavior, and a third portion of the at least one response as consequence, the critical incident being the second portion of the at least one response.

8. (canceled)

9. The computer-implemented method of claim 1, wherein, for each cluster of the plurality of clusters:
that cluster includes a set of responses to the at least one behavioral question and from a plurality of sets of responses,
each response from the set of responses for that cluster being semantically similar to each other response from the set of responses,
each archetype behavior for that cluster representing the set of responses for that cluster.

10. The computer-implemented method of claim 1, further comprising:
verifying the output score based on a feedback from at least one hiring manager; and
updating the model based at least in part on the verification.

11. A computer-implemented method, comprising:
receiving a training dataset that includes a plurality of responses to a behavioral question obtained from a plurality of candidates, each response of the plurality of responses being pre-annotated to represent antecedent-behavior-consequence schema of behavior;
extracting, from each response of the plurality of responses, a behavior from that response to generate a plurality of behaviors based at least in part on the pre-annotation for that response;
clustering into a plurality of clusters the plurality of behaviors based on a semantic similarity of each behavior of the plurality of behaviors to each other behavior of the plurality of behaviors, each cluster from the plurality of clusters associated with a similarity score that is from a plurality of similarity scores and that is calculated based on that cluster and the extracted behavior, the extracted behavior being filtered out in response to the extracted behavior being different from a predetermined number of extracted behaviors that is in the training dataset and that is less than a total number of extracted behaviors in the training dataset;
constructing a set of archetype behaviors for the behavioral question, each archetype behavior of the set of archetype behaviors being representative of a different cluster of the plurality of clusters;
generating behaviorally anchored rating scales (BARS) for the set of archetype behaviors; and
training a model using the training dataset and based on the plurality of clusters and the BARS to produce a trained model.

12. The computer-implemented method of claim 11, further comprising:
identifying, for each response of the plurality of responses, a structure for that response based on the pre-annotation for that response, the structure for that response indicating a first portion in that response representing an antecedent, a second portion in that response representing the behavior for that response, and a third portion in that response representing a consequence.

13. The computer-implemented method of claim 11, wherein the model is a deep neural network.

14. The computer-implemented method of claim 11, wherein generating BARS includes:
obtaining scores provided by hiring managers to the plurality of responses; and
ranking the set of archetype behaviors based at least in part on the scores.

15. The computer-implemented method of claim 11, wherein the set of archetype behaviors is predetermined.

16. The computer-implemented method of claim 11, wherein the set of archetype behaviors is dynamically determined based at least in part on a number of responses to the behavioral question in the training dataset.

17. The computer-implemented method of claim 11, further comprising:
receiving a transcript of a job interview of a candidate, the transcript including a candidate response to the behavioral question; and
outputting, using the trained model, an output score for the candidate response.

18. The computer-implemented method of claim 17, further comprising:
identifying, using the trained model, a candidate behavior from the candidate response; and
classifying, using the trained model, the candidate behavior into a first cluster of the plurality of clusters.

19. The computer-implemented method of claim 11, further comprising:
after clustering and before constructing the set of archetype behaviors, filtering outlier behaviors from the plurality of behaviors.

20. The computer-implemented method of claim 11, wherein generating the BARS includes assigning weight to each archetype behavior from the set of archetype behaviors.
